(19) United States
(12) Patent Application Publication
(10) Pub. No.: US 2008/0247017 A1
(43) Pub. Date: Oct. 9, 2008

(54) SYSTEM AND METHOD FOR PRINTING A HOLOGRAM

(76) Inventors: Kuohua (Angus) Wu, Corvallis, OR (US); Andrew L. Van Brocklin, Corvallis, OR (US); Alexander Govyadinov, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/696,698

(22) Filed: Apr. 4, 2007

(51) Int. Cl. G02B 5/32

(52) U.S. Cl. 359/21; 359/35

(57) ABSTRACT

A system and method for printing a hologram are disclosed. The method includes the operation of transmitting a laser light beam. The laser light beam can be split into an object beam and a reference beam. Phase information can be added to the object beam using a spatial phase modulator to form a phase controlled object beam. The reference beam and the phase controlled object beam can be directed to a predetermined location on a holographic media to enable the reference beam and the phase controlled object beam to form an interference pattern on the holographic media.

### BACKGROUND

When objects and scenes are observed in every day life they appear to have a three dimensional appearance. Simply put, this is made possible by the human vision-brain system interpreting the amplitude, wavelength, and phase of light that reflects off of the objects as they are observed. When recording these objects in photographs, a reduced amount of information results in a loss of the three dimensional image originally perceived. For example, a monochrome photograph records only the amplitude of the light reflected off of the objects that are photographed. A color photograph records sufficient information that the amplitude and a limited reconstruction of the wavelength of the light can be reproduced to allow a color image to be perceived. However, the loss of phase information in both monochrome and color photography, results in the photographs displaying a two dimensional image.

It has been discovered that a three dimensional image of an object or scene can be recorded by storing the amplitude and phase information using diffraction of coherent light. Such a recording is typically referred to as a hologram. FIG. 1 shows a standard method for recording a holographic image. A coherent light beam 102 can be split (using, for example, a beam splitter 104) into an illumination beam 106 and a reference beam 108. The illumination beam and reference beam remain substantially coherent. The illumination beam is used to illuminate an object 110. An object beam 112 is reflected from the illuminated object. The object beam and reference beam combine at a photographic plate 114. Optical interference between the reference beam and the object beam, due to the superposition of the light waves, produces a series of intensity fringes that can be recorded on a photographic media such as standard film. These fringes form a type of diffraction pattern on the film, which is called the hologram.

Once the film is processed, if illuminated again with the reference beam, diffraction from the pattern on the film reconstructs the original object beam in both intensity and phase. Because both phase and intensity are reproduced, the image appears three-dimensional. The viewer can move his or her viewpoint and see the image rotate exactly as the original object would.

Certain types of holograms, known as reflection holograms, can be viewed under an ordinary white light source. Reflection holograms are often used as security features to authenticate important documents or information. For example, packaging for authentic operating system software may include a reflection hologram to show that the software has not been illegally copied. Many credit cards contain reflection holograms to allow customers and retailers to be assured that the cards are original. Holograms are used due to the difficulty in their reproduction.

One method for reproducing a hologram is by using photomasks in a process similar to microchip formation. Another method is by embossing of surface relief holograms to form a binary phase hologram. For example, an original hologram can be formed on a glass plate with a fringe pattern comprising several thousand lines per inch, with each fringe having less than 1 micron depth. Molds of the original hologram can be made and used to form stamps to make duplicate images.

The complexity and cost of forming and mass producing holograms has limited the use of security holograms in common business and security practices. Recently, however, improvements in imaging and printing have allowed holograms to be directly printed using laser type printing devices. The hologram laser printing devices, however, have been limited to using amplitude modulation during printing of the information. A hologram printed using only light amplitude modulation suffers from the limited amount of information that can be imparted during printing. The amplitude hologram can have some of the same problems as a typical photograph, appearing more two dimensional than three dimensional. Additionally, such holograms printed with amplitude only light modulation technique can be copied and reproduced fairly easily. The ease of reproduction of amplitude only holograms produced with hologram laser printers has also reduced the desirability of using holograms created in this fashion for security purposes.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is an illustration of a prior art method for forming a three dimensional hologram;

FIG. 2 is an illustration of a system for printing a hologram, in accordance with an embodiment of the present invention;

FIG. 3 is an illustration of a spatial phase modulator coupled to a driver circuit in accordance with an embodiment of the present invention;

FIG. 4 is an illustration of a wavefront having an adjusted phase using the spatial phase modulator, in accordance with an embodiment of the present invention; and

FIG. 5 is a flow chart depicting a method for printing a hologram in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENTS

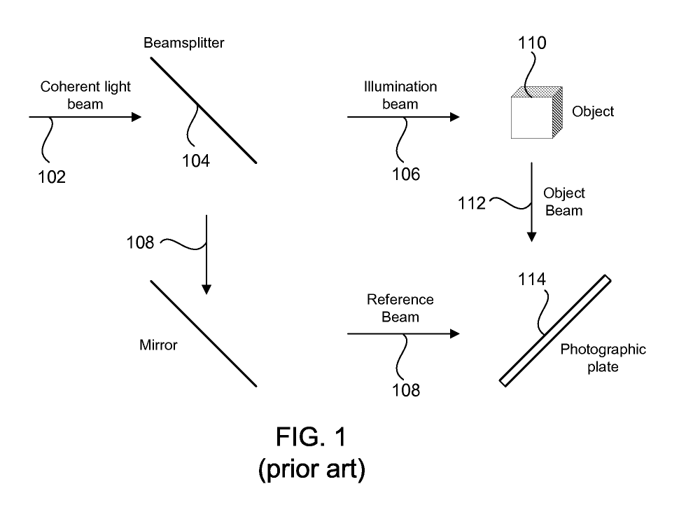

When a hologram is generated using standard analog printing techniques, as shown in FIG. 1, a three dimensional image is generated due to a phase difference between the object beam 112 and the reference beam 106. The phase difference is created by the difference in path length between the two beams. The illumination beam is reflected off of the three dimensional surface of the object. The reflected coherent light from the object 110 then combines with the reference beam 106 at the photographic plate 114. The difference in phase between the two beams of coherent light causes interference patterns which are stored on the photographic plate.

Analog printing, as used in this application, refers to the process of printing an entire page using a fixed format. For example, a newspaper is typically printed using analog printing, in which a printing press employs plates that are used to print each page. The image on the page cannot be changed due to the fixed plates used to print the image.

Holograms used today are typically created in an analog fashion, in which the hologram is created by illuminating the entire photographic plate with the reference beam and the object beam. Copies of holograms are also created in an analog process, typically using a stamping or photomask process to create a holographic image.

In accordance with one aspect of the invention, it has been recognized that a system and method is needed to digitally print a hologram that has a more three dimensional appearance. Digital printing, as used in this application, is the process of printing an image on a page, wherein a portion of the image can be altered. Digital printing of two dimensional images, such as pictures or text, is well known. The pictures or text are stored in a computer and digitally transmitted to a printer, such as a laser printer or inkjet printer.

Thus, digital printing has many advantages over analog printing. Analog printing doesn't allow for a portion of an image to be changed without physically changing the printing process, such as altering the plates of a printing press, or the stamp or photomask of a holographic reproduction. In contrast, digital printing enables an image to be changed on a pixel by pixel basis in a computer, allowing the image to be readily altered and reprinted without the need to change any physical processes.

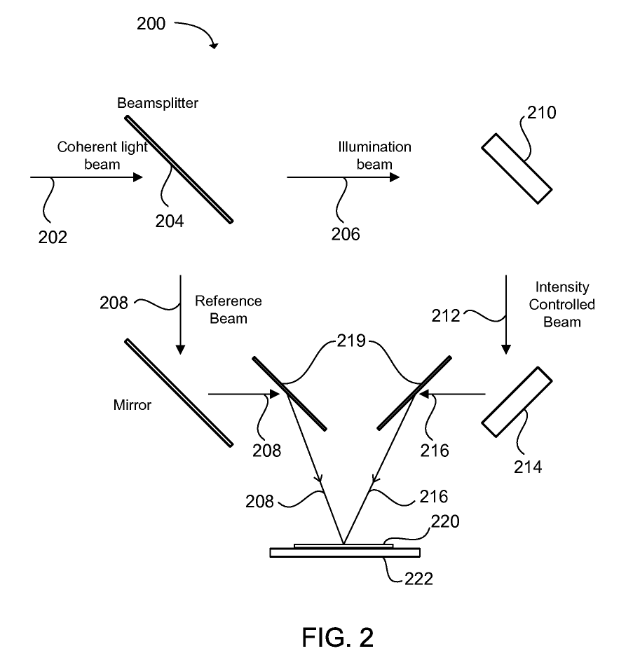

FIG. 2 provides an illustration of a system for digitally printing a holographic image to enable the image to appear three dimensional. In one embodiment, the system 200 includes a coherent light beam 202. The coherent light beam can be generated by any type of coherent light source, such as a solid state or gas laser. The laser output can be continuous or pulsed. A pulsed laser output can generate coherent light having a higher power density, enabling a wider variety of holographic media to be used to record the hologram.

A beam splitter 204 can be used to divide the coherent light beam 202 into a reference beam 208 and an illumination beam 206. In a typical holographic recording setup, as shown in FIG. 1, the illumination beam is used to illuminate a desired object. The amplitude and phase of the light reflected off of the object is used, in conjunction with the reference beam, to record the hologram as previously discussed. In the present system, the object can be replaced with a spatial light modulator 210 (SLM) configured to spatially control an intensity or amplitude of the illumination beam, and a spatial phase modulator 214 (SPM) configured to spatially control a phase of the illumination beam. Using the SLM and the SPM together, the intensity and phase of the illumination beam can be controlled to simulate a desired object.

The wavefront of the illumination beam can be controlled to form a spatial intensity phase controlled beam 216 having substantially similar properties to a beam that is reflected off of the desired object. The amplitude-phase controlled beam can be redirected using a redirection means 219, such as at least one mirror or lens, to direct the amplitude-phase controlled beam towards a holographic media 220. The reference beam 208 can also be redirected using the redirection means 219, or a different means, to substantially the same location on the holographic media. The amplitude-phase controlled beam and the reference beam can interfere to form an interference pattern on the holographic media. The interference pattern can then be recorded in the holographic media.

A more detailed description of the digital holographic printing process will now be described. The illumination beam 206 can be formed using one or more lenses and/or mirrors to provide an illumination beam approximately the same size as the SLM 210 or SPM 214. The SLM can be any type of spatial light modulator capable of spatially controlling the amplitude of the illumination beam. For example, the SLM can comprise a two dimensional array of mirrors.

In a typical SLM having an array of mirrors, the mirrors are used to control the intensity of the illumination beam by directing a certain amount of the incoming light to be output from the SLM using pulse width modulation, as can be appreciated. The output results in a two dimensional image in which each mirror can output light to a location, or pixel, that varies from substantially white to substantially black. A typical SLM can produce 2̂10 (1024) shades of gray between the white and black by directing the mirror between off and on thousands of times a second. “Off” is typically associated with moving the mirror to a first position to direct the light towards a light dump configured to absorb the light. When the mirror is “on”, the mirror is typically moved to a second position to direct the light to be output from the SLM toward optics or a screen. Thus, an SLM is typically a binary, on/off type of device.

A color wheel, or similar device, may be used to allow different colored light to be directed at the SLM. Alternatively, a single wavelength may be used to generate a monochromatic hologram. Other types of spatial light modulators that can be used include a liquid crystal aperture, a grating light valve device, a liquid crystal on silicon device, a Fabry Perot interferometer device, and the like.

An intensity controlled beam 212 that is output from the SLM 210 typically comprises a plurality of intensity controlled beams. The number of beams and the optical properties of the beams will depend on the type of SLM used. For example, a grating light valve comprises hundreds or thousands of ribbons used to diffract the illumination beam. Further optics are typically used to provide an image, as can be appreciated. A spatial light modulator comprising a two dimensional array of mirrors, as previously discussed, will output a plurality of separate beams, with each beam having a desired intensity or brightness. The number of mirrors in the array is dependent upon a preferred level of precision. Typical arrays can comprise 1280×1024 mirrors, 1080×1920 mirrors, or another desired level of precision. Thus, the SLM can output thousands, or even millions of separate beams, each with a controlled intensity or amplitude.

Depending on the type of SLM used, the SPM may need to be located fairly close to the SLM. For example, the small mirrors used to form an array of mirrors typically have sharp edges. The small mirrors with sharp edges can cause the coherent light beam that is reflected from each mirror to spread relatively quickly. In order to direct a substantial amount of the coherent light reflected from each beam output from the SLM to the SPM, the SLM and SPM may need to be located in close proximity. It may even be possible to construct an SLM/SPM in a single chip, or two chips contained in a single package, allowing the mirrors in the SLM and SPM to be within micrometers of each other. A single chip or package having an SLM and a SPM may be referred to as a spatial phase intensity modulator. Alternatively, separate chips can be used and the beams can be optically directed using lenses and/or mirrors to direct the beams over a more distant separation of several inches between the SLM and SPM.

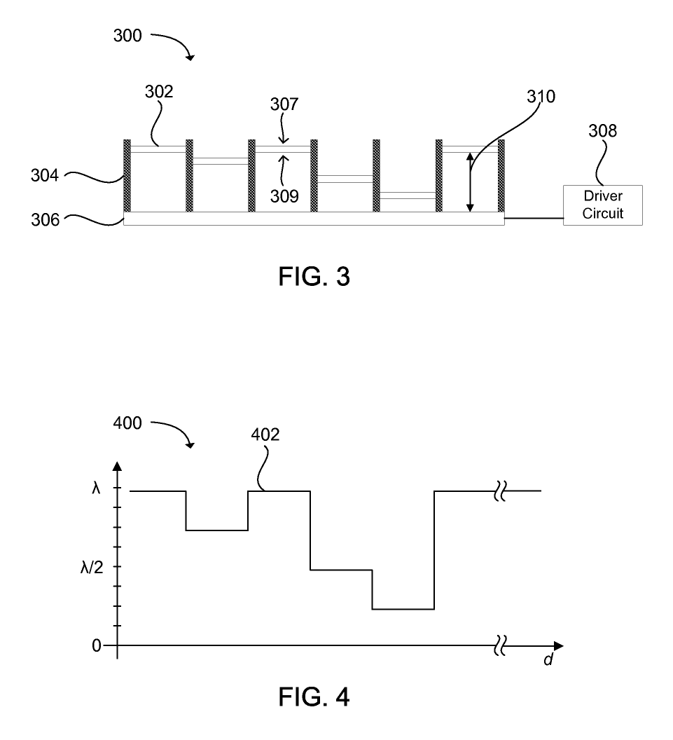

The spatial phase modulator 214 is also comprised of an array of movable mirrors. However, unlike the embodiment of the SLM that was previously discussed, the SPM is not constrained to be a binary type device in which the mirrors tilt between two positions. An illustration of one embodiment of an SPM 300 is shown in FIG. 3. The SPM is comprised of a two dimensional array of mirrors 302. Each mirror can be constructed to reflect a substantially maximum amount of light. For instance, each mirror can be a dielectric mirror having one or more layers of dielectric or metal materials deposited to form an optical coating capable of reflecting at least 99% of the light incident on each mirror. Obviously mirrors having a lower reflectivity can also be used. However, high reflectivity can improve the performance of the SPM. The dielectric coating can be applied on the top 307 of each mirror, to the bottom 309 of each mirror, or to both the top and bottom. The base can be constructed of an optically transparent material, enabling light to be directed toward either the top or bottom of the mirrors 302. Each mirror can be carried by one, two or more supporting arms 304. The supporting arms can include a biasing means, such as a spring (not shown). The spring can bias the mirrors to a maximum or minimum height above the base. The height of each mirror can be adjusted relative to the base. The supporting arms can include stops to control the maximum and minimum heights of the mirrors from the base.

In one embodiment, the height of each mirror can be selected based on a voltage between each mirror and the base. Applying a voltage can create an attractive electrostatic charge that draws each mirror towards the base by a predetermined distance. Alternatively, the biasing means in the arms 304 can be configured to bias the mirrors 302 toward the base 306. A voltage can then be applied between the base and mirrors to drive the mirrors from the base by a predetermined distance through an electrostatic charge. Either way, a predetermined height of the mirror can be selected based on a desired change in phase of the beam hitting the SPM mirror.

In one embodiment, the phase of each beam projected from an SLM can be adjusted to a desired level between zero and 360 degrees. For example, a coherent light beam having a wavelength of 750 nm can be output from the SLM and directed to the SPM 300. The height 310 of each mirror 302 relative to the base 306 can be adjusted by at least 375 nm, or half the wavelength of the coherent light. The coherent light beams can then be reflected from the mirrors in the SPM. The phase of each light beam can be changed by twice the change in height of each mirror, due to the distance each beam travels as it directed toward the mirrors and then reflected away. Thus, a change in height of 375 nm, or half the wavelength of the 750 nm coherent beam, will result in a full wavelength, or 360 degree change in phase. The SPM is not limited to being used with any specific wavelength of coherent light. Different wavelengths of coherent light can also be used. Shorter wavelengths can allow for faster switching rates of the mirrors between desired phases since the mirrors don't have to travel as far. For instance, the mirrors may be adjusted nearly twice as fast for a wavelength of 400 nm coherent light. However, the accuracy needed to adjust a phase of 400 nm light wave is nearly twice the accuracy needed for a 750 nm light wave.

Similarly, the SPM 300 can be configured to have a maximum change in wavelength of less than 360 degrees. In one embodiment, a maximum change in height of each mirror of ¼ of the light's wavelength can be sufficient, which can result in faster switching rates due to the shorter distance traveled by the mirrors.

When a simulated object includes delays, or phase differences of greater than a one or a few wavelengths of light, a delay of n wavelengths, where n is a positive integer, can be added to one or more elements (mirrors) in the output of the SLM 210 (FIG. 2). The delay can be used to account for whole wavelength phase differences in the simulated object that are larger than the change in phase that can be applied with the SPM.

The mirrors 302 can be adjusted in height using a driver circuit 308. The driver circuit can be electrically coupled to the SPM 300 and configured to vary a voltage between each mirror and the base 306 to provide an electrostatic charge sufficient to change a height of each mirror by a predetermined distance. The base, mirrors, support arms 304 and biasing means can all be constructed using typical microelectromechanical system fabrication techniques, as can be appreciated. The driver circuit can be calibrated to compensate for physical differences in the support means used to bias the mirrors. Thus, using the driver circuit 308, it is possible to effectively control the height of each mirror to within a desired tolerance. The driver can also be used to control other types of mechanical or electrical forces useful in moving the mirrors to a desired location, as can be appreciated.

The height of each mirror 302 can be varied using either digital or analog means. For example, the driver circuit 308 can be configured to output a continuously variable voltage to each mirror, allowing the height of the mirror to be continuously adjusted in height to provide substantially any phase change of between 0 and 360 degrees. Alternatively, the driver may be configured to output a digital voltage with 2ⁿ different voltage settings, allowing for 2ⁿ possible height adjustments, where n is an integer.

For instance, FIG. 4 shows an illustration of a one dimensional optical wavefront, with the phase of the wavefront controlled using the SPM 300 of FIG. 3. In this example embodiment, the mirrors are adjusted using a driver configured to output a digital voltage with 23 different settings, allowing for 8 different positions for each mirror between 0 and λ, or 360 degrees. This allows the mirror to change the phase of the optical wavefront 402 at each mirror location in the array of mirrors by approximately 0, 45, 90, 135, 180, 225, 270, 315 and 360 degrees. It is also possible that the change in height of each mirror may be constrained to less than a 360 degree change in phase due to physical limitations of the distance each SPM mirror can move.

Thus, the SPM 300 of FIG. 3, comprising a two dimensional array of mirrors, can be used to alter a phase of a two dimensional optical wavefront. The two dimensional optical wavefront can be output from an SLM, as previously described. Alternatively, in another embodiment, the wavefront may be directly received from a coherent light source. In the latter embodiment, the phase of the wavefront can be adjusted as desired and then directed toward an SLM where the intensity or amplitude of the wavefront can be adjusted to form an image. Alternatively, the output of the SPM may be sent directly to the holographic media 220 (FIG. 2) without use of the SLM 210 to form a phase hologram.

Returning to FIG. 2, the spatial phase controlled beam or spatial intensity/phase controlled beam 216 (referred to hereinafter as the spatial controlled beam) can be directed toward the holographic media 220, as previously discussed. The spatially controlled beam 216 can interfere with the reference beam 208 to form an interference pattern which can be recorded using the holographic media.

The holographic media 220 can be any type of light sensitive media capable of recording the interference pattern. Examples of typically holographic media include silver halide film, Omnidex™ manufactured by Dupont™, and other types of photographic emulsions, dichromated gelatin, photoresists, photothermoplastics, photopolymers, photochromics, and photorefractives. The amount of laser power needed to record a hologram onto the holographic media is dependent upon the type of holographic media used and the length of exposure. For example, a pen type solid state laser may be sufficient to record a hologram onto silver halide film. However, much more power is required to record a hologram using photopolymers and photothermoplastics. A pulsed gas laser may be used to obtain sufficient power to record a hologram within an acceptable time frame.

The holographic media 220 can be carried by a backing 222, such as a paper, plastic, metal, or glass. The backing can be used to provide support to the holographic media. The backing can also provide a medium for printing additional information. For example, an identification card may be comprised of a paper or plastic backing upon which information is included. A portion of the card can include a holographic media carried by the card backing. The holographic printing system 200 can be used to print a phase hologram or a phase-amplitude hologram onto the holographic media. A traditional printer can be used to print additional information on the backing. The holographic printing system and a traditional printing system can be included in a single device configured to print on both the backing and the holographic media.

In one embodiment, a hologram can be printed on the holographic media 220 by illuminating the entire holographic media at one time with the spatially controlled beam 216 and the reference beam 208 for a period sufficient to allow an interference pattern to be recorded.

In another embodiment, the spatially controlled beam 216 and reference beam 208 can be directed to cover a selected portion of the holographic media 220. The remaining media can be covered to prevent it from being exposed. Multiple selected portions of the media can be sequentially exposed to allow the spatially controlled beam and reference beam to be directed to the desired areas of the holographic media.

Unlike traditional printing methods, where different subsections of an image are printed in the correct location to provide a complete image, creating a larger or more detailed hologram can be accomplished by recording the same holographic information (interference pattern) on the holographic media two or more times, as can be appreciated. Thus, a larger and/or more detailed hologram can be created by focusing the spatially controlled beam and reference beam to illuminate a portion of the holographic media, recording the interference pattern within the portion, and moving the media or beams to record one or more additional sections of the media with substantially the same interference pattern to form a larger holographic image or an image having more information.

Additionally, the amount of information recorded on the media is the sum of the information content of the phase modulator and the amplitude modulator. If these modulators each can convey 8 megabits of information, then the information imparted to the media could reach a total of 16 megabits. This information translates into greater visual control over the appearance of the finished hologram.

A digital image can be used to provide information to the spatial light modulator 210, as can be appreciated. For example, the SLM can be used to replicate a grayscale or color image from a digital picture stored on a computer. The digital picture includes information relating to the amplitude or intensity of the image which can be replicated using the two dimensional array of binary mirrors in the SLM. Similarly, a digital camera can be used to record phase information of an image. The phase information relates to a shape of the wavefront reflected in an image recorded by a digital camera that is configured to record phase, such as a digital camera having a charged coupled device detector array. The phase information can then be stored in a digital format and sent to the SPM to adjust a height of each of the mirrors in the array of mirrors to simulate the shape of the wavefront in the recorded image.

In another embodiment, phase information can be calculated using a computer program configured to simulate an object. For example, a computer automated display (CAD) program can be used to simulate an object such as a chess piece. A ray tracing program can then be used to calculate a phase of rays reflected from the simulated object. The calculated phase values can be used to control the SPM 214 to recreate a three dimensional image of the simulated object on the holographic media 220.

The holographic printing system 200 can be incorporated within a variety of different types of printers. In one embodiment, the holographic printing system can be included in a laser printer. The coherent light beam 202 may be obtained from a typical laser used in a laser printer. Alternatively, a separate laser may be used that is dedicated to the holographic printing system. Other types of printers which can be used in conjunction with the holographic printing system include inkjet printers, bubble jet printers, liquid-electro-photographic printers, and the like.

The holographic printing system 200 can be used to print three dimensional holographic images. The use of a spatial phase modulator 214 allows the holographic images to appear three dimensional. In another embodiment, the spatial phase modulator can be used to encode an image. Encoding can be accomplished by incorporating a predetermined change in phase onto the holographic image. Instead of using the SPM to simulate a wavefront from a photographed or simulated image, the SPM can be controlled to form a selected phase pattern. The selected phase pattern can be based on a visual pattern, an equation used to control a height of each mirror in the SPM, a selection of height of each mirror in the SPM based on a pseudorandom pattern, and the like.

The selected phase pattern can be used to optically encode a holographic image. The optical code may be detectable by a person, or may require machine detection such as a holographic reader. The phase pattern can be used to create a holographic image which cannot be easily duplicated. For example, a hologram having a predetermined phase pattern can be attached to an important object or document. A person receiving the object or document can determine its validity based on the visual or machine detection of the selected phase pattern in the object. The holographic printing system provides a simple and inexpensive way to create document and object verification based on encoded holographic images that are difficult to reproduce. This allows people receiving objects or documents having encoded holograms attached to be ensured of their legitimacy.

When the holographic printing system 200 is used to encode an image, the spatial phase modulator 214 can be placed either in the reference beam 208 or the illumination beam 206. To replicate an image of the object, the same information can be used to enable the SLM and the SPM to have substantially the same setting as when the holographic image was formed, as previously described. The electronic key can be transmitted, hand carried, or otherwise sent to a recipient of the encrypted hologram. The recipient can use a holographic image encryption system 200, or a similar system having a spatial phase modulator that can be setup with the electronic key. A recipient can use the properly setup spatial phase modulator to view an encrypted holographic image to authenticate that the object, document, or information affixed to or associated with the holographic image is genuine.

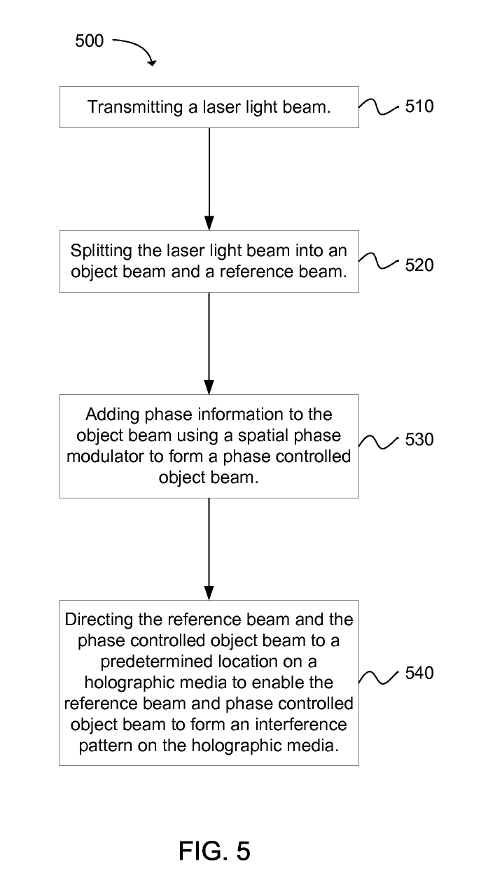

Another embodiment provides a method 500 for printing a hologram, as shown in the flow chart of FIG. 5. The method includes the operation of transmitting 510 a laser light beam. A further operation involves splitting 520 the laser light beam into an object beam and a reference beam. An additional operation includes adding 530 phase information to the object beam using a spatial phase modulator to form a phase controlled object beam. A further operation provides directing 540 the reference beam and the phase controlled object beam to a predetermined location on a holographic media to enable the reference beam and phase controlled object beam to form an interference pattern on the holographic media.

The holographic media can be used to record the interference patterns. For example, Omnidex™ can be used to record the interference patterns. Omnidex™ is a photopolymer that can be treated with ultraviolet light and heat after it has been illuminated with the interference pattern. The interference pattern changes the index of refraction of the photopolymer based on the intensity of exposure. The index changes the speed of light as it travels through the photopolymer, enabling a user to view a three dimensional holographic image that was recorded.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for printing a hologram, comprising:
transmitting a laser light beam;
splitting the laser light beam into an object beam and a reference beam;
adding phase information to the object beam using a spatial phase modulator to form a phase controlled object beam;
directing the reference beam and the phase controlled object beam to a predetermined location on a holographic media to enable the reference beam and phase controlled object beam to form an interference pattern on the holographic media.

2. A method as in claim 1, further comprising adding amplitude information to the object beam using a spatial light modulator comprising a plurality of reflective elements to form an amplitude-phase controlled object beam prior to directing the beam onto the holographic media.

3. A method as in claim 2, further comprising forming an interference pattern on the holographic media configured to record the interference pattern, wherein the holographic media is selected from the group consisting of photographic emulsions, dichromated gelatin, photoresists, photothermoplastics, photopolymers, photochromics, and photorefractives.

4. A method as in claim 2, further comprising adding a delay of n wavelengths to the object beam using at least one of the plurality of reflective elements in the spatial light modulator, wherein n is a positive integer.

5. A method as in claim 1, wherein adding phase information to the object beam further comprises adding phase information to the object beam using the spatial phase modulator, wherein the spatial phase modulator comprises a two dimensional array of mirrors disposed above a base, wherein a plurality of mirrors in the two dimensional array are configured to have an adjustable height relative to the base to enable a phase of the object beam directed toward the plurality of mirrors to be adjusted relative to a change in height of the plurality of mirrors.

6. A method as in claim 5, further comprising controlling the spatial phase modulator with a driver electrically coupled to the spatial phase modulator, the driver configured to provide a sufficient voltage between the base and at least one of the plurality of mirrors to change the height of the mirror relative to the base based on an electrostatic charge induced by the voltage.

7. A method as in claim 5, further comprising controlling the spatial phase modulator with a driver electrically coupled to the spatial phase modulator, the driver configured to control a sufficient force between the base and at least one of the plurality of mirrors to change the height of the mirror relative to the base.

8. A method as in claim 6, further comprising calibrating a control of each of the plurality of mirrors using the driver, wherein the calibration is configured to substantially remove mechanical differences in changing the height of the plurality of mirrors to enable each of the plurality of mirrors to be adjusted to a desired height.

9. A method as in claim 1, further comprising encoding phase information in a hologram using the spatial phase modulator by incorporating a predetermined change in phase onto a holographic image.

10. A method as in claim 9, further comprising detecting the encoded phase information in the holographic image to enable a person to verify the holographic image is authentic.

11. A system for printing a hologram, comprising:
a laser configured to emit a laser light beam;
a splitter configured to divide the laser light beam into an object beam and a reference beam;
a spatial phase modulator configured to add phase information to the object beam to form a phase controlled object beam;
an optical redirection device for directing the phase modulated object beam and the reference beam to a predetermined location on a holographic media to enable the reference beam and phase controlled object beam to form an interference pattern on the holographic media.

12. A system as in claim 11, wherein the spatial phase modulator is comprised of a two dimensional array of mirrors, each mirror being slidably carried by at least one arm.

13. A system as in claim 12, wherein the arms are coupled to a back, said back configured to receive a voltage relative to the mirrors to enable a height of at least one of the mirrors to be adjusted based on an electrostatic charge induced by the voltage.

14. A system as in claim 11, further comprising a spatial light modulator configured to add amplitude information to the object beam to form an amplitude-phase controlled object beam.

15. A system as in claim 14, wherein an output of one of the spatial phase modulator and the spatial light modulator is directed toward the other of the spatial phase modulator and the spatial light modulator to form the amplitude-phase controlled object beam.

16. A system as in claim 14, wherein the spatial phase modulator and the spatial light modulator are constructed to be contained within at least one of a single package and a single chip to form a spatial phase intensity modulator.

17. A system as in claim 11, wherein the laser is selected from at least one of the group consisting of a solid state laser, a gas laser, a continuous laser, and a pulsed laser.

18. A system as in claim 11, wherein the holographic media is carried by a backing comprising at least one of paper, plastic, metal, and glass, the backing being configured to have additional information printed thereon.

19. A system for printing a hologram, comprising:
a means for transmitting a laser light beam;
a means for splitting the laser light beam into an object beam and a reference beam;
a means for adding phase information to the object beam using a spatial phase modulator to form a phase controlled object beam;
a means for directing the reference beam and the phase controlled object beam to a predetermined location on a holographic media to enable the reference beam and phase controlled object beam to form an interference pattern on the holographic media.

20. A system as in claim 19, further comprising a covering means for covering a portion of the holographic media to enable the holographic media to be exposed a plurality of times at an uncovered portion of the holographic media.

21. A method of making a holographic printer configured to print a three dimensional holographic image, comprising:
providing a laser configured to emit a laser beam;
positioning a light dividing means configured to split the laser beam into a reference beam and an object beam;
locate a spatial phase modulator in a path of the object beam to form a phase controlled object beam;
situating a beam redirection means in a path of at least one of the object beam and the reference beam to direct the reference beam and the phase controlled object beam to a substantially similar location on a holographic media to form an interference pattern on the holographic media.

22. A method of making as in claim 21, further comprising locating a spatial light modulator in a path of the object beam to form an intensity-phase controlled object beam.

23. An article of manufacture comprising:
a computer usable medium having computer readable program code means embodied therein for causing a printer to print a three dimensional digital hologram, the computer readable program code means in said article of manufacture comprising:
computer readable code means for causing a laser to transmit a laser beam directed toward a splitting means, wherein the splitting means is configured to split the laser beam into a reference beam and an object beam, the reference beam being directed toward a holographic media and the object beam being directed toward a spatial phase modulator comprising a two dimensional array of mirrors, wherein a plurality of the mirrors have an adjustable height relative to a base of the spatial phase modulator; and
computer readable code means for causing a computer to control a driver circuit, the driver circuit being electrically coupled to the spatial phase modulator, wherein the driver circuit is configured to vary a voltage between the plurality of mirrors and the base to provide an electrostatic charge sufficient to change a height of at least one of the plurality of mirrors by a predetermined distance to change a phase of a wavefront of the object beam to form a phase controlled beam, wherein the phase controlled beam is directed toward the holographic media to interfere with the reference beam and form an interference pattern on the holographic media.
